(19) United States
(12) Patent Application Publication
(10) Pub. No.: US 2018/0015834 A1
(43) Pub. Date: Jan. 18, 2018

(54) FAST CHARGING HOME SYSTEM FOR AN ELECTRIC VEHICLE

(71) Applicant: GM GLOBAL TECHNOLOGY OPERATIONS LLC, Detroit, MI (US)

(72) Inventors: Peter T. Karlson, Rochester Hills, MI (US); David S. Maxwell, Madison Heights, MI (US); Rick W. Szymcyk, Whitby (CA); Pablo Valencia, JR., Northville, MI (US)

(21) Appl. No.: 15/212,357

(22) Filed: Jul. 18, 2016

(51) Int. Cl. B60L 11/18

(52) U.S. Cl. CPC B60L 11/185; B60L 11/1842; B60L 11/1805; B60L 11/1811; B60L 11/1818

(57) ABSTRACT

A system for fast charging an electric vehicle includes a power plug, a charger, a stationary battery, a DC/DC converter, at least one DC fast charge connector and a control unit. The power plug may be a plug which is operatively configured to engage with a standard 120V power source or a 240V power source. The charger may be a unidirectional charger or a bidirectional charger. The DC fast charge connector is adapted to be removably affixed to an electric vehicle. The control unit is in communication with at least two of the charger, the DC/DC converter, the stationary battery, and the DC fast charge connector to provide fast charge to an electric vehicle.

### TECHNICAL FIELD

The present disclosure concerns charging stations for electric vehicles, and particularly charging station systems and methods particularly designed for retrofit into homes or other locations with existing wiring.

### BACKGROUND

Electric vehicles (EVs) and plug in hybrid electric vehicles (PHEVs) comprise a bank of batteries and an on-board charger, which converts household AC power to DC power at the voltage required for charging the batteries.

Due to the limited mileage of electric vehicles, owners usually prefer to recharge at home while drawing power from the grid via a wall mounted charge station in their garages or car ports. Charging is usually performed overnight in order to provide the full mileage range every day. Typically, charge stations comprise a flexible cable and docking station for the dedicated charge connector as well as various control check and safety components.

In the United States, most wall outlets deliver 120 volt power via a circuit breaker in the household electric panel. The majority of homes also have 240V outlets, located in the kitchen or laundry area, which serve to power ranges, washer/dryers and air conditioners. Until the appearance of electric vehicles, garage power outlets were mostly used incidentally to operate power tools, garage door openers, lighting, etc.

The capacity of the battery bank in an electric vehicle may typically be from 20 to 50 kWh, and when fully depleted, the battery bank will require on the order of 10 to 20 hours of charging time when powered from a 120V outlet. This amount of time is generally considered too long by EV owners and for this reason most residential EV charge stations require a dedicated 240 volt outlet, enabling a max power output of 3600 or 4800 VA while still drawing 15 or 20 amperes respectively. Thus, the effect of having a 240V outlet as compared to a 120V outlet is to cut the excessive charging times mentioned above in half.

One way of saving the extra cost of a new 240 volt outlet is to convert the original 120V circuit to 240V. The conversion can be done inexpensively without additional wire drawing by exchanging the single circuit breaker in the power panel with a double circuit breaker, thereby converting the former neutral wire in the circuit to a hot wire. However, a negative effect of the conversion is the loss of the 120 volt outlets in the garage area, which were served by the former 120 volt circuit.

The wiring needs to modify a home which include wiring from the house power panel may well be on the order of $1,000 to $2,000, far exceeding the cost of the charge station itself. Moreover, typical home systems require a significant amount of time (such as 20 hours) for a user to charge a vehicle.

Although several prior art U.S. patents and published patent applications, including U.S. Pat. Nos. 8,072,184 and 8,013,570 and U.S. Patent Application Publication Nos. 2011/0174875 and 2011/0140656, disclose charging stations for electric vehicles having, in some embodiments, charging cords or outlets for charging at 240V, and also charging cords or outlets for charging at 120V, the disclosed charging stations require a user to set aside several hours (such as 20 hours) to allow for the home system to charge an electric vehicle.

Obviously, traditional methods are quite cumbersome for a home user. Accordingly, a need has developed for to allow home users to easily fast-charge their electric vehicle at home.

### SUMMARY OF THE INVENTION

Accordingly, it is an object of the present invention to provide a system and method for a home user to fast charge their electric vehicle at home with a system that is easy to implement at home.

A system for fast charging an electric vehicle includes a power plug, a charger, a stationary battery, a DC/DC converter, at least one DC fast charge connector and a control unit. The power plug may be operatively configured to be in electric communication with at least one of a standard 120V power source or a 240V power source. The charger may be a unidirectional charger or a bidirectional charger. The DC fast charge connector is adapted to be removably affixed to an electric vehicle. The control unit is in communication with at least two of the charger, the DC/DC converter, the stationary battery, and the DC fast charge connector to provide fast charge to an electric vehicle.

The invention and its particular features and advantages will become more apparent from the following detailed description considered with reference to the accompanying drawings.

### BRIEF DESCRIPTION OF THE DRAWINGS

FIG. 1 is a schematic diagram of the fast charging home system of the present disclosure.

FIG. 2 is flow chart which illustrates the steps of the method of fast charging a vehicle in accordance to various embodiments of this disclosure.

### DETAILED DESCRIPTION OF THE INVENTION

In a general sense, the present invention is directed to an at-home fast charging system 10 for an electric vehicle 36. Electric vehicles 36 are appealing to consumers given that energy storage capacity of vehicle batteries are increasing every day. With the introduction of lithium ion batteries, there has been an improvement in the electric vehicle industry. Moreover, the cost for fuel may be more than the cost for electricity required to travel the same distance, and electric vehicles have very low emissions of waste gases relative to gasoline vehicles.

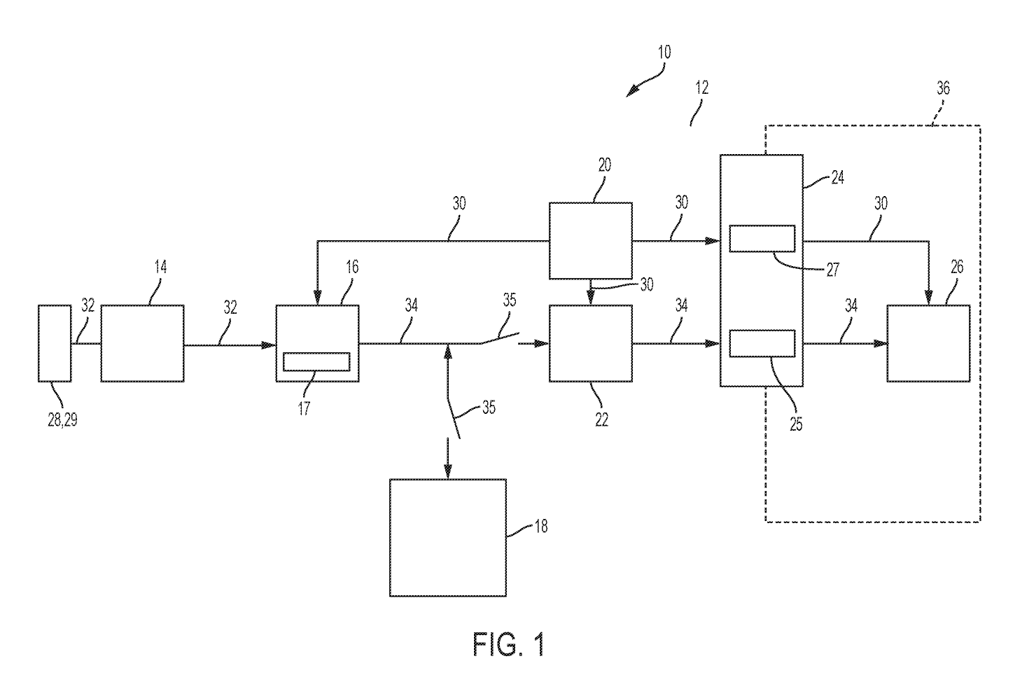

The present disclosure provides a system 10 and method for fast charging an electric vehicle 36. With reference to FIG. 1, various embodiments of the system 10 of the present disclosure may be implemented at any powered location, including but not limited to a home residence where it may be difficult to implement or costly to fast charge an electric vehicle 36. In an embodiment of the present disclosure, the system 10 may include a power plug 14, a charger 16, a stationary battery 18, a DC/DC converter 22, at least one DC fast charge connector and a control unit 20. As indicated, the aforementioned fast charging system 10 may be easily installed in a residence while providing a user with the ability to fast charge an electric vehicle 36. The stationary battery 18 may serve as a unit to store power as explained herein.

As shown in FIG. 1, the present disclosure provides for an at-home fast charging system 10 which may implement either a unidirectional or bidirectional charger 16. In the event that a bi-directional charger 16 is used, the system 10 of the present disclosure can provide stored power from the stationary battery 18 back to the electric grid 29 of the building/home in the event of an electricity outage or as needed. As indicated, the stationary battery 18, may be a repurposed vehicle battery instead of a new battery thereby serving as a renewable source of energy even after the battery is removed a vehicle. The bidirectional charger 16 may charge the stationary battery 18 during times when power demand is low, and the stationary battery 18 may then later be used as an energy source to the building (or residence) when power demands are higher.

The power plug 14 implemented in the fast charging system 10 may be a plug which is configuratively adapted to fit into either a 120V outlet or a 240V outlet. The power plug 14 (when inserted into an outlet) is in electrical communication to the building's electric grid 29 or power source 28. Homes, and other like building structures, generally have several 120 volt outlets and a few 240 volt outlets where the power is in the form of an alternating current (AC). This power plug 14 for the 120V or 240V outlet is accordingly used as part of the system 10 of the present disclosure. The power plug 14 is in electric communication with a charger 16 that may be a unidirectional charger or a bidirectional charger.

The bi-directional charger 16 includes a multi-purpose circuit 17 which may perform 3 operations, they are: 1) AC-DC conversion 2) DC-DC conversion and 3) DC-AC conversion. The DC/DC converter function of the multi-purpose circuit 17 in the bi-directional charger serves to restore power from a higher voltage power such as but not limited to 340V-400V to a standard voltage power such as 120V or 240V depending on the building's power outlet. For example, when power is supplied back to the building's electric grid 29 from the base battery 18, any higher power voltage such as a voltage at 340V-400V may need to be stepped down to 120V or 240V power given that most building/home outlets have 120V outlets and some 240V outlets. The DC/DC converter function of the multi-purpose circuit 17 also serves to step up 120V power received from a 120V outlet on the electric grid 29 (via the power plug 14) so that the voltage increases to a level for initial storage on the stationary battery 18. One non-limiting example of an increased voltage for initial storage on the stationary battery 18 may but not necessarily be in a range of 340V-400V.

As shown in FIG. 1, the AC-DC and DC-DC conversion by the charger 16 may be controlled by control signals 30 generated by the control unit 20. It is understood that the vehicle user may interface with the system 10 of the present disclosure via a user interface (not shown) which is in communication with the control unit 20. The control signals 30 cause the necessary switching action for the conversions at the charger 16 to take place. Switches 35 are activated according to control signals 30 from the control unit 20. As indicated earlier, the DC-DC conversion in the forward direction performs the buck operation and in the reverse direction it performs boost operation. Therefore, this charger 16 may regulate the DC voltage.

The schematic diagram of FIG. 1 illustrates how the voltage may change in the fast charging system 10 of the present disclosure. Higher voltage power 34 may, but not necessarily, be in the range of 340V to 400V (DC) while standard voltage power 32 may, but not necessarily, be in the range of 120V-240V (AC). DC/DC converter 22 may serve to step up 120V power received from a 120V outlet (or 240V power from a 120V outlet) on the electric grid 29 (via the power plug 14) so that the standard voltage power 32 increases to a non-limiting example range of 340V-400V (DC) or as needed by the electric vehicle 36. Outside of stepping up the standard voltage power, the DC/DC converter 22 may be a high efficiency converter which can step down higher voltage power 34 as needed.

The stationary battery 18 may be a new battery or a repurposed vehicle battery thereby reducing waste. The stationary battery 18 may, but not necessarily, be contained in a housing unit 12 together with at least the charger 16 and the DC/DC converter 22. The DC/DC converter 22 may be a high efficiency converter which is configured to step up or step down the input voltage so that it may be useable by any one of the following: vehicle battery 26, stationary battery 18, or building grid 29. Moreover, the efficient nature of the DC/DC converter 22 together with having stored power in the stationary battery 18 allows the system to fast charge a vehicle battery 26 at a user's home.

With reference to the control unit 20 (also referenced as a charge controller) in FIG. 1, it is understood that a user may communicate with the system 10 of the present disclosure via a user interface (not shown). The control unit 20 is operatively configured to send control signals 30, as shown, to the any one or more of the following components: the charger 16, the DC/DC converter 22 as well as the charge connector 24 in order for the system 10 to operate smoothly. These control signals 30 may include but are not limited to the following commands: (1) transmit power from the stationary battery back to the electric grid 29 or power source 28; (2) transmit power from the power grid 29 to the charger 16 and converter so that the power may be transmitted to the charge connector 24 for use by an electric vehicle; (3) transmit power from the electric grid 29 or power source 28 to the stationary battery for storage; (4)) transmit power from the stationary battery so that the power may be transmitted to the charge connector 24 for use by an electric vehicle.

It is understood that system of the present disclosure simply requires a user to only connect to the DC charge port even when the system is charging at a rate usually associated with AC charging. It is understood that any one of a variety of DC fast charging standard connectors that are available in the market may be used with the system of the present disclosure.

Referring again to the specific non-limiting exemplary embodiment shown in FIG. 1, the fast charge station system 10 of the present invention may be wall or pedestal mounted system. The fast charging system may be connected with a 240V AC circuit (via a 240V outlet) either by fixed wiring or via a power plug 14 having an appropriate 240V power plug 14. Alternatively, the charge station may connected with a 120V AC circuit either by fixed wiring or via a power cord 2 with an appropriate 120V power plug 12.

It is to be understood that the power plug 14, the charger 16, the stationary battery 18, the DC/DC converter 22, the control unit 20 and at least one DC fast charge connector form a system 10 may be easily installed a residence without the need to hire an electrician. With respect to the DC fast charge connector 24, the DC fast charge connector 24 couples the fast charger system 10 to the electric vehicle and transmits DC power to the electric vehicle 36 via DC pins 25 which are included in the DC fast charge connector 24. The control pins 27 transmit control signals 30 to the vehicle 26. Accordingly, the DC fast charge connector 24 may be removably coupled to the electric vehicle 36 in order to transfer power from at least one of the stationary battery 18 and electric grid 29 to the vehicle battery 26.

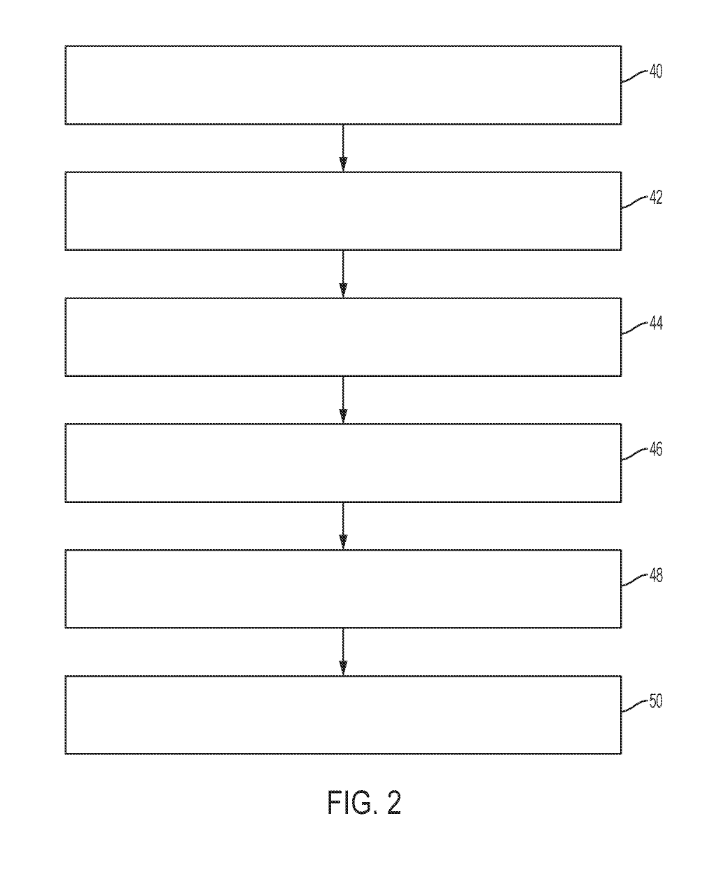

Referring now to FIG. 2, a flow chart is provided which illustrates a method for fast charging an electric vehicle with the aforementioned system 10. The method includes the steps of transforming 40 power from an electric grid at a charger to a higher voltage power 34; transferring 42 the higher voltage power 34 from the charger to a stationary battery 18 for initial storage; transferring 44 high voltage power from the stationary battery to a DC/DC converter and then to a vehicle battery until the stationary battery power has been substantially depleted; drawing 46 standard power from a grid at a power plug; transforming 48 standard power at a charger to a higher voltage power; transferring 50 the higher voltage power to a DC/DC converter and then to a vehicle battery via a DC fast charge connector 24.

It is understood that the steps of transmitting or transferring power to the vehicle battery 26 includes the step of removably affixing a DC fast charge connector 24 to a port on the electric vehicle. The DC fast charge connector 24 has DC pins included as part of the connector and it may also include AC pins as well.

With respect to transforming power 40 from an electric grid at a charger to a higher voltage power, the standard voltage power (shown as 32 in FIG. 1) is drawn from an electric grid 29 or power source 28 via power plug 14. This power may be drawn from the grid during non-peak hours. The standard voltage power 32 is transformed at charger 16 to a higher voltage power 34. As indicated, this higher voltage power 34 may be initially stored in stationary battery 18 for later use. When a user is ready to charge the electric vehicle 26, the control signal 30 from the control unit 20 closes switches 35 for the stationary battery 18 and DC/DC converter 22 so that high voltage power 34 from the stationary battery 18 may be sent to DC/DC converter 22 and then to a vehicle battery via the control pins 25 of the DC fast charge connector 24 until the stationary battery power 18 has been substantially depleted. In order to finish charging the vehicle battery 26, control unit 20 signals the system 10 to draw standard voltage power 32 from a grid 29 via a power plug 14. This standard voltage power 32 may be transformed to a higher voltage power 34 at charger 16 and at DC/DC converter 22 for use in a vehicle battery 26 via the DC pins of DC fast charge connector 24 such that a user may quickly charge a depleted vehicle battery 26 such that the vehicle battery 26 is fully charged. This time for charging the vehicle battery 26 may depend on the relative capacity of the stationary battery 18 and the vehicle battery 26. It is to be understood that the present disclosure contemplates a flexible system in how the stationary battery's capacity is sized based on physical size constraints, cost and desired amount of fast charge.

Accordingly, the system of the present disclosure may allow for X kWh of energy to be put into the vehicle battery very quickly (where X kWh is the capacity of the stationary battery 18) from the stationary battery 18 and the remainder (if any) of the energy to fully charge the vehicle battery 26 is transferred to the vehicle battery at a household rate. Accordingly, it is understood that the stationary battery 18 may be sized the same as the vehicle battery 26 such that the vehicle battery 26 could be fast charged off of the stationary battery 18.

As discussed above, the system (or charging station) 10 of the present invention is particularly, but not necessarily, adapted for use in connection with a home residence to allow a user to fast charge their electric vehicle 36 at home given that the present disclosure may accommodate a 120V or a 240V power circuit and has the capability to provide “ample voltage” to an electric vehicle 36 from the grid 29 and/or the stationary battery 18. One non-limiting example of “ample voltage” may be at 340V to 400V (DC).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for fast charging an electric vehicle comprising:
a power plug;
a charger that is one of a unidirectional charger or a bidirectional charger;
a stationary battery;
a DC/DC converter;
at least one DC fast charge connector adapted to be removably affixed to an electric vehicle; and
a control unit in communication with the charger, DC/DC converter, the stationary battery, and the DC fast charge connector.

2. The system of claim 1 wherein the power plug is configured to be in electric communication with one of a 240V power source or a 120V power source.

3. The system of claim 1 wherein the stationary battery is operatively configured to provide power back to a grid upon receiving a control signal from the control unit.

4. The system of claim 1 wherein the bidirectional charger is operatively configured to provide energy management and backup services to the house via energy stored in the stationary battery.

5. The system of claim 1 wherein the power plug, the charger, the stationary battery, the DC/DC converter, the control unit and at least one DC fast charge connector form a complete system which may be installed at a home residence.

6. The system of claim 1 wherein the at least one DC fast charge connector removably couples the vehicle to at least one of the control unit or the DC/DC converter.

7. The system of claim 1 wherein the at least one DC fast charge connector includes at least one of a plurality of DC pins or a plurality of control pins.

8. The system of claim 1 wherein the stationary battery is a repurposed battery.

9. The system of claim 2 wherein the power plug is in electric communication with a charger.

10. The system of claim 1 wherein the at least one DC fast charge connector transmits energy to the vehicle from at least one of the stationary battery and the charger.

11. The system of claim 1 further comprising a housing unit which contains at least the charger, the stationary battery, and the DC/DC converter.

12. A method for fast charging an electric vehicle comprising the steps of:
transmitting power from a grid to a stationary battery for initial energy storage;
transferring power from the stationary battery to a DC/DC converter and then to a vehicle battery via a charge connector until the stationary battery has been exhausted of all power;
drawing power from a grid at a power plug;
transmitting the power from the grid to a DC/DC converter; and
transmitting the power from the DC/DC converter to the electric vehicle via a DC fast charge connector.

13. The method of claim 12 wherein a control unit communicates with at least two of the charger, the stationary battery, the DC/DC converter, and the at least one DC fast charge connector.

14. The method of claim 12 wherein the step of transmitting the power to the vehicle battery from the at least one DC fast charge connector includes the step of removably affixing the at least one DC fast charge connector to a port in the electric vehicle.
